(19) United States
(12) Patent Application Publication
(10) Pub. No.: US 2009/0302494 A1
(43) Pub. Date: Dec. 10, 2009

(54) METHOD MANUFACTURE OF WEATHERSTRIPS USING ULTRA HIGH MOLECULAR WEIGHT POLYETHYLENE ONTO SCF EXTRUSION SYSTEM

(75) Inventors: Joon Chul Park, Gyeonggi-do (KR); Jeong Seok Oh, Gyeonggi-do (KR); Seong Hoon Lee, Ulsan (KR); Byung Kwon Min, Gyeonggi-do (KR)

Correspondence Address: EDWARDS ANGELL PALMER & DODGE LLP, P.O. BOX 55874, BOSTON, MA, 02205, US

(73) Assignee: HYUNDAI MOTOR COMPANY, Seoul (KR)

(21) Appl. No.: 12/271,101

(22) Filed: Nov. 14, 2008

(30) Foreign Application Priority Data
Jun. 4, 2008 (KR) 10-2008-0052679

(51) Int. Cl. B29C 47/00

(52) U.S. Cl. 264/176.1

(57) ABSTRACT

There is provided a process of preparing an automotive weatherstrip by co-extrusion of UHMWPE and TPV materials with an SCF. The automotive weatherstrip according to the present invention can be easily recycled, shows excellent properties with respect to lightweight and fire-resistance, and also contributes to improve the product quality by preventing exterior damage.

### CROSS-REFERENCE TO RELATED APPLICATION

This application claims under 35 U.S.C. §119(a) the benefit of Korean Patent Application No. 10-2008-0052679 filed Jun. 4, 2008, the entire contents of which are incorporated herein by reference.

### BACKGROUND

(a) Technical Field

The present disclosure relates to a method of preparing an automotive weatherstrip by processing ultra high molecular weight polyethylene (UHMWPE), which can substitute a metal support used in preparing conventional weatherstrips.

(b) Background Art

With the recent trend of emphasizing environmental importance, needs are increasing for developing lightweight and recyclable materials. Automobile industry is not an exception.

A weatherstrip is one of the parts of a vehicle, which is used to prevent dust, water and other exterior substances from entering the vehicle. In general, the weatherstrip is combined with a vehicle body flange member for waterproofing and sound shielding purposes. It also servers as a buffering material in the event of contact between automotive parts.

FIG. 1 shows the shape of a conventional weatherstrip and the position of a metal support in the weatherstrip. As shown in FIG. 1, a sealing part equipped in a conventional automotive flange comprises a tube member (10) and a carrier member (20). The tube member (10) is positioned to be in contact with a door frame, a door panel (12) and a door trim. The carrier member (20) supports the tube member and facilitates the insertion and separation of the parts regardless of the shape of flange members. The carrier member (20) comprises a metal support (21), a protrusion (22), and a gripper (23). The metal support (21) maintains the cross-sectional shape of the sealing part and stably fixes it in a desired position. The protrusion (22) guides the sealing part to a desired direction and helping it being fixed in a desired position,. The gripper (23) is positioned on a portion of the vehicle body to which the weatherstrip is attached, such that it is in contract with a flange (25) to prevent the sealing part from being separated from the vehicle body. The flange (25) is configured to comprise a number of panels which varies depending on the region of the vehicle body.

One of the widely used materials for preparing the weatherstrip is ethylene-propylene-diene-poly-methylene (EPDM) vulcanized rubber or polyvinyl chloride (PVC).

Methods for preparing a weatherstrip using EPDM vulcanized rubber, however, have drawbacks. For example, corners or end portions of extruded product are required to be formed in a separate process which is a complicated process involving use of a rubber press. Press-processability with respect to viscosity at a room temperature of EPDM mixture is very sensitive according to exterior temperature. Accordingly, processability varies with the seasons, causing product failure. The rubber press consumes a significant amount of energy to press viscous lead rubber. Further, the low transportation speed of templates increases man hour. The EPDM material is required to be cross-linked, which needs a long process line and a huge space. As it is cross-linked, it is difficult to be recycled, thus increasing economical loss and raising environmental problems. Further, due the heavy weight of a metal support, the weight and manufacturing cost of the weatherstrip is increased.

Therefore, there is an urgent need for the development of a lightweight and recyclable weatherstrip that can resolve the aforementioned problems.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

To overcome the aforementioned problems, the present invention aims to provide a weatherstrip that is easily recyclable, has excellent properties such as lightweight and superior fire-resistance, and also improves product quality by preventing exterior damage.

The present invention relates to a method of preparing a weatherstrip, comprising the steps of: introducing UHMWPE into an extruder for molding the UHMWPE; melting the UHMWPE in the extruder for molding the UHMWPE and molding the UHMWPE into ‘⊂’-like shape by a die provided in the extruder for molding the UHMWPE; introducing a thermally processable solid TPV having crosslinkage-induced rubbery property into an extruder for molding the solid TPV and melting the solid TPV in the extruder for molding the solid TPV; introducing a thermally processable and sponge-like TPV having crosslinkage-induced rubbery property into an extruder for molding the sponge-like TPV and melting the sponge-like TPV in the extruder for molding the sponge-like TPV; introducing an SCF into the extruder for molding the sponge-like TPV and uniformly mixing and dispersing the sponge-like TPV and the SCF; co-extruding the ‘⊂’-shaped UHMWPE, the sponge-like completely vulcanized TPV comprising uniformly dispersed supercritical fluid, and the completely vulcanized solid molten TPV in an extrusion head of the extruders for molding the solid and sponge-like TPVs; and transporting the co-extruded weather strip to an outside through an exclusive die provided in the extrusion head.

Preferably, the method may further comprise the step of finishing the co-extruded weatherstrip in a sizing mold.

Preferably, the method may further comprise the step of cooling the finished weatherstrip in a cooling tank.

Non-limiting example of the SCF is nitrogen (N₂).

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).

As referred to herein, a hybrid vehicle is a vehicle that has two or more sources of power, for example both gasoline-powered and electric-powered vehicles.

The above and other features of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 shows the shape of a conventional weatherstrip and the position of a metal support in the weatherstrip;

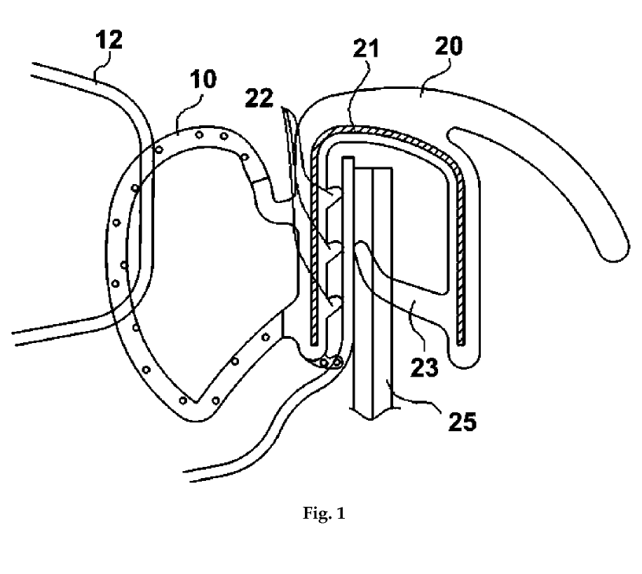

FIG. 2 shows an extrusion system for automotive weatherstrip according to the present invention;

FIG. 3 shows an extrusion head according to the present invention;

FIG. 4 schematically shows a process of preparing automotive weatherstrip by using an SCF extrusion system and UHMWPE;

FIG. 5 is a cross-section of an example of the weatherstrip produced by a method according to an embodiment of the present invention; and

FIG. 6 is a cross-section of another example of the weatherstrip produced by a method according to an embodiment of the present invention.

Reference numerals set forth in the Drawings include reference to the following elements as further discussed below:

| | |
|---|---|
| 10: Tube member | 12: Door panel |
| 20: Carrier member | 21: Metal support |
| 22: Protrusion | 23: Gripper |
| 25: Flange | 30: UHMWPE material |
| 31: Solid TPV material | 32: Sponge-like TPV material |
| 33: SCF fluid | 34: Extrusion head |
| 35: Die | 36: Extruder for molding |
| | UHMWPE |
| 37: Die exclusively for molding | |
| UHMWPE | |
| 38: Sizing mold | 39: Cooling tank |

41: Inlet where [symbol] -shaped UHMWPE material is introduced
43: Inlet through which completely vulcanized solid molten TPV is
introduced
44: Inlet through which sponge-like completely vulcanized TPV
comprising uniformly dispersed supercritical fluid is introduced
45: Extruder for molding solid TPV
46: Extruder for molding sponge-like TPV

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to the preferred embodiments of the present invention, examples of which are illustrated in the drawings attached hereinafter, wherein like reference numerals refer to like elements throughout. The embodiments are described below so as to explain the present invention by referring to the figures.

Hereunder is provided a process of preparing an automotive weatherstrip by using an SCF extrusion system and UHMWPE.

The present invention relates to a method comprising the steps of: (a) introducing UHMWPE into an extruder for molding the UHMWPE; (b) melting the UHMWPE in the extruder for molding the UHMWPE and molding the UHMWPE into [symbol] -like shape by a die provided in the extruder for molding the UHMWPE; (c) introducing a thermally processable solid TPV having crosslinkage-induced rubbery property into an extruder for molding the solid TPV and melting the solid TPV in the extruder for molding the solid TPV; (d) introducing a thermally processable and sponge-like TPV having crosslinkage-induced rubbery property into an extruder for molding the sponge-like TPV and melting the sponge-like TPV in the extruder for molding the sponge-like TPV; (e) introducing an SCF into the extruder for molding the sponge-like TPV and uniformly mixing and dispersing the sponge-like TPV and the SCF; (f) co-extruding the [symbol] -shaped UHMWPE, the sponge-like completely vulcanized TPV comprising uniformly dispersed supercritical fluid, and the completely vulcanized solid molten TPV in an extrusion head of the extruders for molding the solid and sponge-like TPVs; and (g) transporting the co-extruded weather strip to an outside through an exclusive die provided in the extrusion head. The order of the steps is not limited to the above-described order. For example, the step (c) can be performed before the step (a).

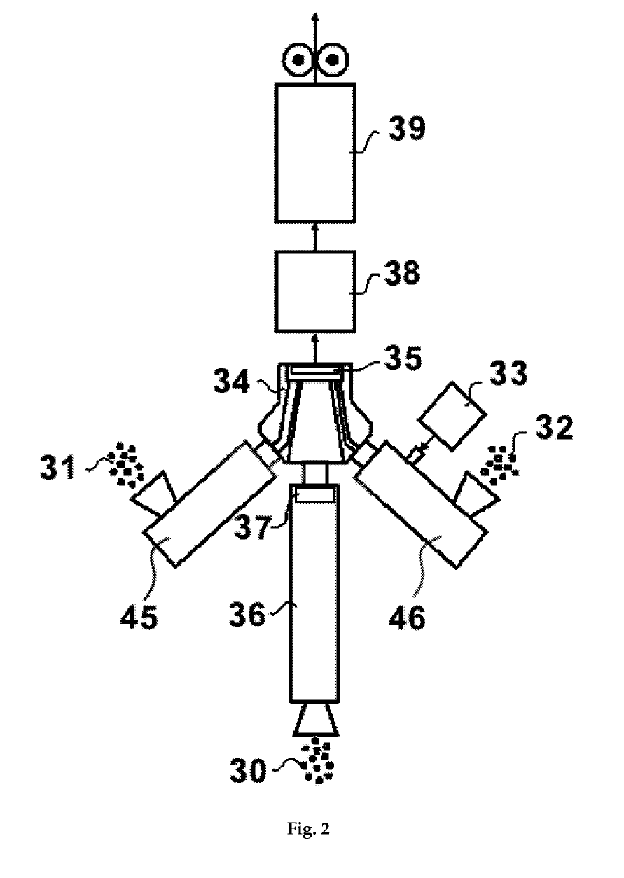

FIG. 2 shows an extrusion system for manufacturing an automotive weatherstrip according to the present invention.

Preferably, the SCF extrusion system has an average particle size of 150-200 μm. The SCF extrusion system may suitably comprise a molding extruder (36) for UHMWPE material which comprises an exclusive die (37) and an exclusive pressure-resistant cylinder for melting the UHMWPE material to be suitable for processing.

UHMWPE material has superior impact resistance, abrasion resistance and chemical resistance, strength and elasticity. It is hard to elongate and break. The molecular weight of UHMWPE is about 3,500,000-10,500,000 g/mol, which is by far higher than that (approximately, 10,000-500,000 g/mol) of other common polymers. In particular, UHMWPE is superior or similar to steel in resistance to abrasion or impact while it is lighter than steel. The density of UHMWPE is 0.95, lower than that of water. Despite its light weight (five times lighter than conventional metal support), UHMWPE shows better strength than steel due to its high molecular weight.

According to the present invention, UHMWPE material is introduced into the extruder (36), and molded into [symbol] shape through the exclusive die (37). Compared with the conventional processes involving a metal support, this process improves overall productivity significantly as the pre-foaming and post-foaming processes required in the conventional processes. It also saves energy costs significantly as UHMWPE is lighter.

The UHMWPE introduced to the extruder (36) is completely melted so as to be suitable for molding. It can be injection-molded at various temperatures, thereby improving productivity by reducing cycle time. Completely vulcanized solid TPV (TPV: thermoplastic vulcanizate, 31) material and sponge-like completely vulcanized TPV (TPV: thermoplastic vulcanizate, 32) material may reduce the production of burr caused by loss of raw material and mold damage without requiring vulcanization process.

Extruders (45, 46) for molding TPV materials (31, 32) are provided to prepare a microcellular foamed weatherstrip. The extruders (45, 46) are provided with an extrusion head (34). The extrusion head (34) is provided with an exclusive die (35).

The extruder for molding the sponge-like TPV (46) comprises a screw pressure-resistant cylinder exclusively for uniformly mixing and dispersing SCF (33) with the TPV material (32). That is, the TPV material (32) is introduced through a hopper of the extruder (46), SCF is introduced and they are completely mixed in the extruder (46). The exposure to atmospheric pressure causes expansion to the outside.

Herein, SCF (33) is defined as any substance at a temperature and pressure above its thermodynamic critical point, and has particular characteristics different from those of normal gases and liquids. The critical point represents the highest temperature and pressure at which the substance can exist as vapor and liquid in equilibrium. A non-limiting example of the SCF is nitrogen (N₂).

Foam, which is prepared by uniformly mixing and dispersing completely vulcanized solid TPV (31), sponge-like completely vulcanized TPV (32) and SCF (33), meets [symbol] -shaped UHMWPE, and they are transported to outside through the exclusive die (35).

The weatherstrip transported outside may, suitably, be finished in a sizing mold (38) to a desired shape. The thus-finished weatherstrip may, suitably, be cooled in a cooling tank (39).

The above-described processes may be conducted in a batch mode, a continuous mode, or semi-continuous mode.

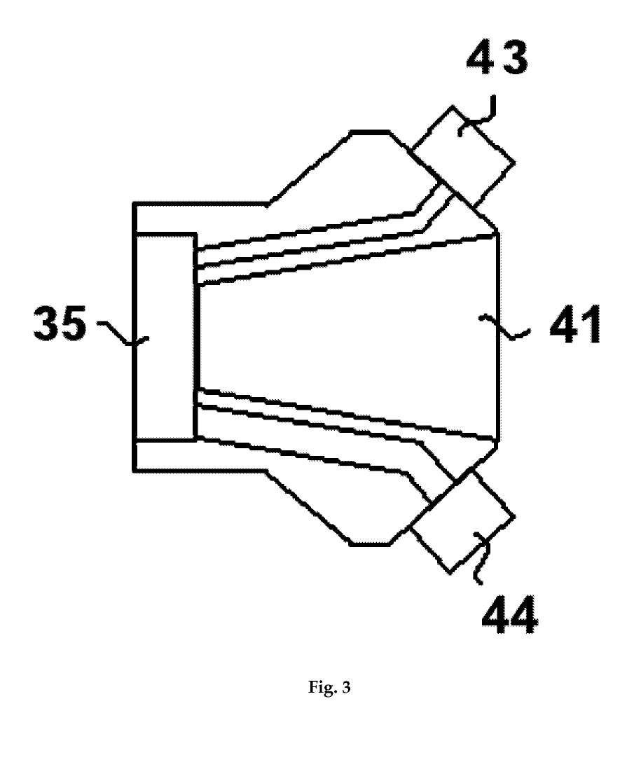

FIG. 3 shows an extrusion head according to the present invention.

The [symbol] -shaped UHMWPE material is transported to the exclusive die (35) via an inlet provided in the central region of the extrusion head (41), the sponge-like completely vulcanized TPV comprising uniformly dispersed supercritical fluid is transported via an inlet (43), and the completely vulcanized solid molten TPV is transported via an inlet (44). Therefore, the [symbol] -shaped UHMWPE, solid TPV material and sponge-like TPV material become in contact with each other and is three-layer co-extruded. The mixture passes through the die (35). While no foaming happens within the extruder, exposure to atmospheric pressure causes expansion of sponge-like completely vulcanized TPV (32) and SCF (33) to the outside.

### EXAMPLES

The following examples illustrate the invention and are not intended to limit the same.

Manufacture of Weatherstrip

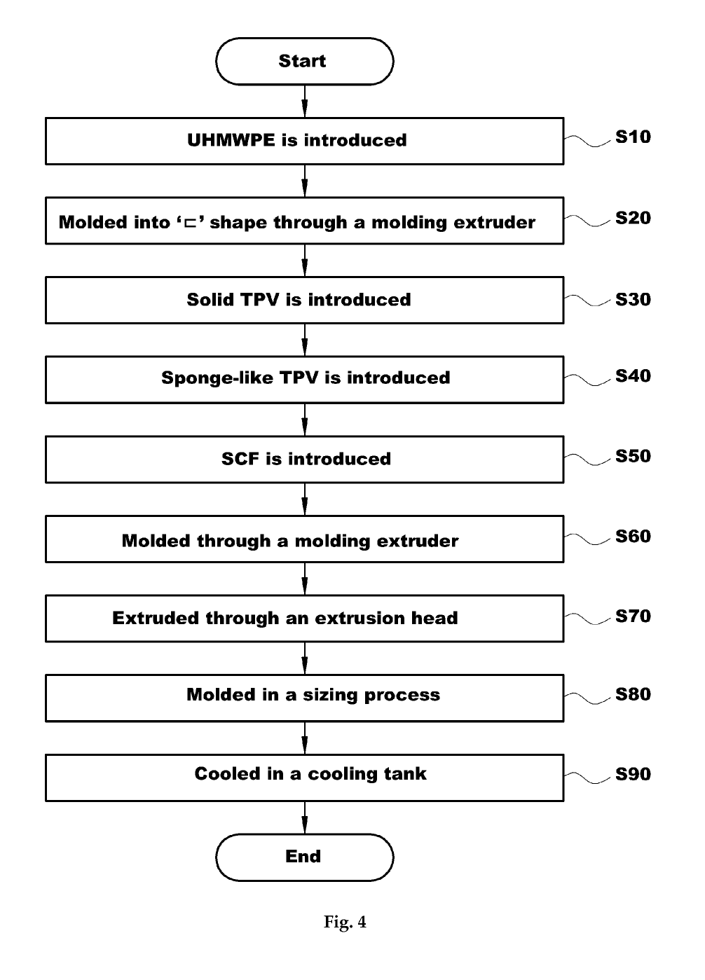

FIG. 4 schematically shows a process of preparing an automotive weatherstrip by using the above-described system.

As shown in FIG. 4, UHMWPE was introduced in an extruder for molding the UHMWPE (S10). The temperature of the cylinder of the extruder was maintained at 190° C. The introduced UHMWPE was completely melted after 3 minutes in the extruder cylinder, processed into [symbol] shape through an exclusive die (37), and transported to an extrusion head (S20).

A thermally processable solid TPV (31) having crosslinkage-induced rubbery property was introduced into an extruder for molding the solid TPV (S30). A thermally processable and sponge-like TPV (32) having crosslinkage-induced rubbery property was then introduced into an extruder for molding the sponge-like TPV (S40). As an SCF, nitrogen (N₂, 33) was introduced into the extruder for molding the sponge-like TPV (S50). The mixture was molded through the extruder for molding the sponge-like TPV (S60).

The [symbol] -shaped UHMWPE, the sponge-like completely vulcanized TPV comprising uniformly dispersed supercritical fluid, and the completely vulcanized solid molten TPV were co-extruded in an extrusion head (34) of the extruders (45, 46).

The thus-obtained co-extruded weatherstrip was transported to outside via the exclusive die (35) of the extrusion head (34) (S70).

The weatherstrip transported to outside was finished in a sizing mold (S80). The finished weatherstrip was cooled at 10° C. in a cooling tank (S90).

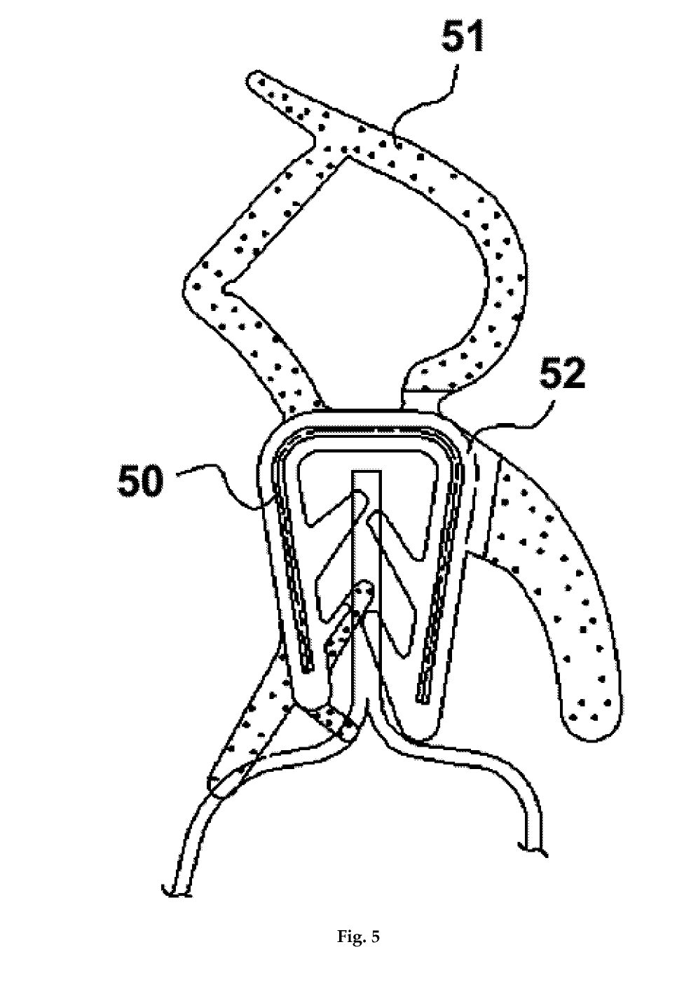

FIG. 5 is a cross-section of a weatherstrip produced by the method as described in FIG. 4. The reference number 50, 51, and 52 denote [symbol] -shaped UHMWPE, sponge-like foamed TPV, and solid TPV, respectively.

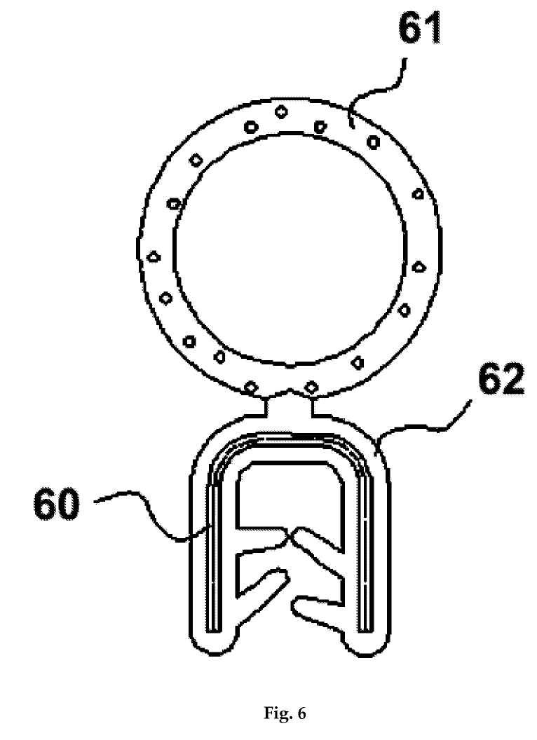

FIG. 6 is a cross-section of another weatherstrip prepared by the method as described in FIG. 4. The reference number 60, 61, and 62 denote [symbol] -shaped UHMWPE, sponge-like foamed TPV, and solid TPV, respectively.

As described above, the use of recyclable TPV materials in preparing a weatherstrip reduces waste production, and the development of a foamed material reduces the amount of raw materials used. Further, simplified process by using UHMWPE improves the productivity and price competitiveness. In addition, the exterior appearance of products can be improved by removing marks of a metal support from the surface of a carrier.

It should be noted that although the methods according to the present invention are described with respect to a weatherstrip of a vehicle, the methods can be applied to any type of sealing parts of a vehicle and any other type of machines and devices and such application is also within the scope of the present invention.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A method of preparing a weatherstrip comprising:
(a) introducing UHMWPE into an extruder for molding the UHMWPE;
(b) melting the UHMWPE in the extruder for molding the UHMWPE and molding the UHMWPE into [symbol] -like shape by a die provided in the extruder for molding the UHMWPE;
(c) introducing a thermally processable solid TPV having crosslinkage-induced rubbery property into an extruder for molding the solid TPV and melting the solid TPV in the extruder for molding the solid TPV;
(d) introducing a thermally processable and sponge-like TPV having crosslinkage-induced rubbery property into an extruder for molding the sponge-like TPV and melting the sponge-like TPV in the extruder for molding the sponge-like TPV;
(e) introducing an SCF into the extruder for molding the sponge-like TPV and uniformly mixing and dispersing the sponge-like TPV and the SCF;
(f) co-extruding the [symbol] -shaped UHMWPE, the sponge-like completely vulcanized TPV comprising uniformly dispersed supercritical fluid, and the completely vulcanized solid molten TPV in an extrusion head of the extruders for molding the solid and sponge-like TPVs; and
(g) transporting the co-extruded weather strip to an outside through an exclusive die provided in the extrusion head.

2. The method of claim 1, further comprising the step of (h) finishing the co-extruded weatherstrip in a sizing mold.

3. The method of claim 2, further comprising the step of (i) cooling the finished weatherstrip in a cooling tank.

4. The method of claim 1, wherein the SCF is nitrogen (N₂).
